(19) United States
(12) Patent Application Publication
(10) Pub. No.: US 2005/0226232 A1
(43) Pub. Date: Oct. 13, 2005

(54) Differentiated management of non-umts traffic in a umts access network

(76) Inventors: Tan-Nhon Pham, Antony (FR); Christophe Preguica, Massy (FR)

Correspondence Address: SUGHRUE MION, PLLC, 2100 PENNSYLVANIA AVENUE, N.W., SUITE 800, WASHINGTON, DC, 20037, US

(21) Appl. No.: 10/523,934

(22) PCT Filed: Jun. 24, 2003
(86) PCT No.: PCT/FR03/01930

§ 371 Date: Mar. 29, 2005

(51) Int. Cl. H04L 12/66

(52) U.S. Cl. 370/356

(57) ABSTRACT

Telecommunication terminal having means for transmitting a stream of packets of data to an access router to a telecommunication network, characterized in that it comprises means for inserting client information into said stream indicating if said stream corresponds to a mobile telephone standard or not.

The present invention relates to the infrastructures of mobile networks, especially third generation mobile networks, usually referred to as Universal Mobile Telecommunication System (UMTS) networks.

To be more precise, it relates to a router, in particular an access router, belonging to the above kind of network, and to a terminal connected to that network.

Third generation mobile terminals need, on the one hand, a high transmission capacity in order to be able to convey multimedia data such as pictures, video, etc. and, on the other hand, the application of quality of service constraints such as a guaranteed minimum bit rate, an end-to-end transmission delay, a loss rate or a level of jitter between two consecutive data packets not exceeding a given threshold.

Moreover, the UMTS specifications state that the access network to convey the traffic should conform to the Internet Protocol (IP). To be more precise, from version 5 of the UMTS specifications, the protocol must be the Internet Protocol, version 6 (IPv6).

The above network is commonly referred to as the UMTS Terrestrial Radio Access Network (UTRAN).

Moreover, there may be provision for the network additionally to convey traffic of “non-UMTS” subscribers, i.e. traffic with or without a specified quality of service. The network then behaves vis à vis other networks as a data transmission service provider.

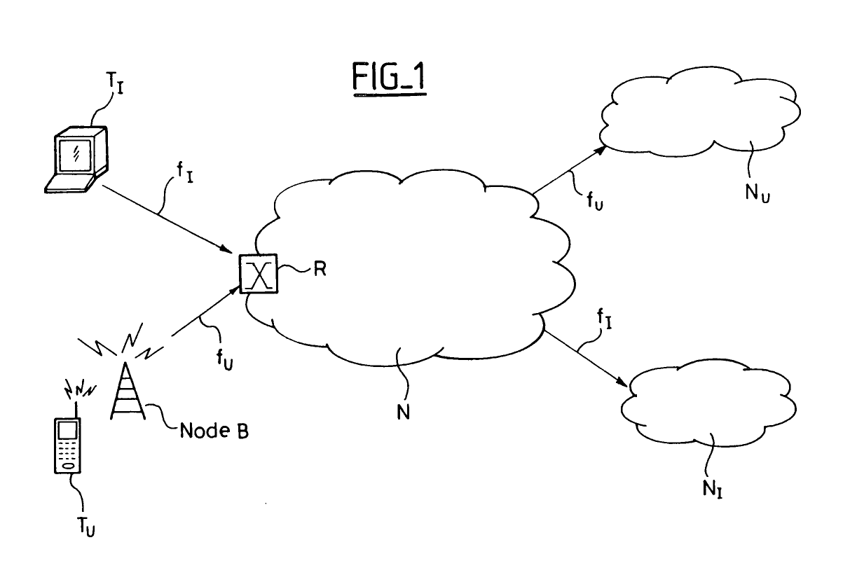

FIG. 1 illustrates this situation.

A UMTS terminal Tu is able to communicate with a router R via a base station Node B and therefore to transmit data in the network N. The data transmitted in this way forms a multimedia stream fᵤ. The multimedia stream fᵤ is conveyed by the network N before it is transmitted to a UMTS core network N_{U}. The multimedia data is typically voice, pictures or video (or possibly data), and is associated with demanding quality of service constraints, as mentioned above.

Moreover, a terminal Tᵢ, for example a microcomputer, is able to communicate with the same router R and to transmit its data in the network N. That data forms a data stream fᵢ that is conveyed by the network N and transmitted to the network Nᵢ.

In this example, it is therefore apparent that the network N conveys two types of traffic: traffic composed of multimedia streams (referred to as “multimedia traffic”) and traffic composed of streams of data that is not necessarily multimedia data (referred to as “data traffic”). More generally, a network N is able to convey UMTS traffic (here multimedia traffic) and non-UMTS traffic (here data traffic).

This sharing of the resources of the network N between two traffics may cause a problem because, if the amount of data traffic becomes sufficiently high, it may penalize the multimedia traffic and therefore risk compromising the quality of service criteria.

An object of the present invention is to solve this problem.

To this end, the present invention consists firstly in a telecommunication terminal comprising means for transmitting a stream of packets of data to an access router to a telecommunication network. This terminal is characterized in that it comprises means for inserting client information into said stream indicating if said stream corresponds to a mobile telephone standard.

In one embodiment of the invention, the mobile telephone standard is a mobile telephone standard such as the UMTS standard. However, the invention is open to any other third generation mobile telephone standard or any other “2.5” generation mobile telephone standard such as that of the General Packet Radio Service (GPRS) system.

In particular, it may be applied to the NE 2000 or i-mode systems specified by the Japanese company NTT.

The client information is preferably inserted into a packet header. This header may in particular be the hop-by-hop option header.

The invention secondly consists in a router belonging to a telecommunication network and comprising means for receiving streams of packets of data. According to the invention, the router is characterized in that it comprises:
means for determining if said stream corresponds to a mobile telephone standard from client information inserted in said stream, and
means for implementing quality of service assurance mechanisms as a function of what is determined in this way.

In one embodiment of the invention, the quality of service assurance mechanisms depend on other information on the client contained in the stream.

In one embodiment of the invention, the router is additionally provided with means for notifying a billing server, indicating if the stream corresponds to a mobile telephone standard.

The invention and its advantages will become more clearly apparent in the course of the following description, which is given with reference to the appended drawings.

FIG. 1, already commented on, shows the context of the invention.

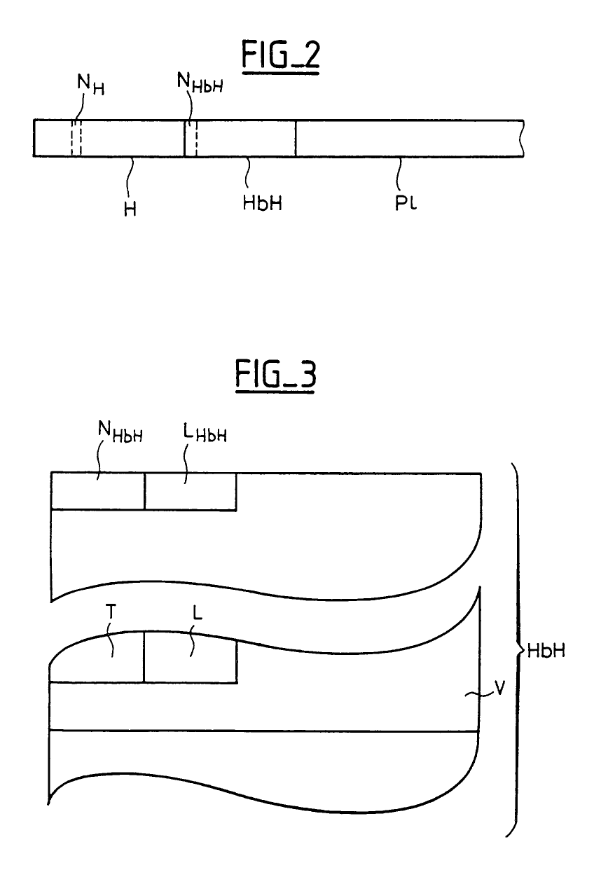

FIG. 2 shows the format of an IPv6 data packet.

FIG. 3 shows the composition of a “Hop by Hop” header conforming to the invention.

According to the invention, a telecommunication terminal may be a mobile terminal conforming to a mobile telephone standard such as the UMTS standard or a terminal, mobile or otherwise, for transmitting data traffic. The latter terminal may be a fixed or portable microcomputer or a personal digital assistant (PDA), for example.

These telecommunication terminals include means for transmitting streams of data packets via an access router to a telecommunication network. Those means can be radio communication interfaces or cable connections.

According to the invention, the telecommunication terminals also include means for inserting into the streams of data packets client information indicating whether the streams correspond to a mobile telephone standard or not, in particular to the UMTS standard that is considered by way of example hereinafter.

Accordingly, if the terminal is a UMTS terminal, it inserts client information indicating that the streams are UMTS streams.

Conversely, if the terminal is not a UMTS terminal (for example a microcomputer) it inserts client information indicating that the streams are not UMTS streams.

This client information can be inserted into the packets belonging to the stream of data packets. It is preferably inserted into a header of the packets.

In the context of a UMTS system, the telecommunication network typically conforms to version 6 of the Internet Protocol (IPv6). This protocol is defined by the Request For Comments (RFC) 2460 of the Internet Engineering Task Force (IETF) published in December 1998.

FIG. 2 shows the format of an IPv6 data packet. According to the IPv6 specifications, a data packet comprises a succession of headers and a message body.

The message body may conform to immediately higher level protocols such as the Transport Control Protocol (TCP) or the User Datagram Protocol (UDP).

The succession of headers includes at least one IPv6 header H which necessarily appears first and includes information needed for routing the packet within the network.

Other headers may optionally be present between the IPv6 header H and the message body, also known as the payload (PL). These other headers may include “hop-by-hop” headers, routing headers, fragment headers, destination option headers or authentication headers.

The stringing of the headers is managed according to the value of the “next header” field in each header.

In the FIG. 2 example, only an optional “hop-by-hop” header HbH is shown. Its presence is indicated by a zero value of the “next header” field N_{H} of the IPv6 header H. Similarly this header HbH includes a field N_{HbH} indicating that the header HbH is followed by the payload PL (and not another optional header).

The characteristic feature of the “hop-by-hop” header is that it has to be read and analyzed by all the routers (or other network elements) conveying the packet.

The header comprises a set of optional fields (possibly only one such field). Each optional field is of the Type-Length-Value (TLV) type and therefore comprises three sub-fields:
the first indicates the option type,
the second indicates the length of the next sub-field, and
the third indicates a value corresponding to that type.

In one embodiment of the invention, the client information is inserted as an option into the hop-by-hop header.

FIG. 3 shows this embodiment and represents the various fields constituting the header HbH. This header includes firstly the fields N_{HbH} described above and the field L_{HbH} giving the total size of the header HbH.

It further includes one or more options. Here only one option is shown, that containing client information. This option contains firstly a sub-field T. The value of this sub-field is characteristic of the type of information contained by the option. This value must typically be a value assigned by the Internet Assigned Number Authority (IANA).

The sub-field V indicates the value and the sub-field L indicates the length of the sub-field V.

For example, the sub-field V may occupy six bytes, in which case the value of the sub-field L is 6 and the total length of the option is eight bytes.

The value of the sub-field V indicates the client information, i.e., firstly, if the stream corresponding to the packet containing it is a UMTS stream or not.

It may also indicate other information on the client. For example, it may indicate a quality of service requested by the client: “gold”, “silver”, “bronze”, etc.

Accordingly, all the routers receiving this kind of packet must read the “hop by hop” header and, by doing so, determine if the stream of which the packet is part corresponds to a mobile telephone standard. In one embodiment of the invention, they can additionally obtain more precise information on the client.

They can then implement quality of service assurance mechanisms as a function of what they determine.

Typically only the access router R bears the responsibility for implementing such mechanisms.

For example, it may use the DiffServ technology as specified in IETF RFC 2474. In this case, it may simply assign a different color to each of the values of the client information (i.e. the value of the sub-field V).

Accordingly, each subsequent router transmitting the packet and implementing the DiffServ technology will convey UMTS packets and non-UMTS packets differently. From the point of view of the network, it then becomes possible to give priority to dealing with UMTS packets so that quality of service constraints are complied with.

In one embodiment of the invention, it is possible to convey the streams differently as a function of other information on the client.

Returning to the previous example, streams requiring a “gold” quality of service could be processed with higher priority than streams requiring only a “silver” or “bronze” quality of service.

An alternative embodiment uses a Resource ReSerVation Protocol (RSVP) technology as specified in IETF RFC 2205.

In this embodiment, the access router R creates a signaling packet that is transmitted in the network N and enables the reservation of resources within that network, in order to guarantee conformance with the quality of service specified in the signaling packet.

The quality of service is then determined by the access router as a function of the client information, which indicates if the stream is a UMTS stream.

For example, if the packet does not belong to a UMTS stream, no signaling packet is sent; on the other hand, if the packet does belong to a UMTS stream, a signaling packet is sent, requesting a quality of service:
either as a function of the client, i.e. as a function of information contained in the client information, as indicated above,
or corresponding to a moderate quality of service.

To the extent that the network N (the UMTS access network) behaves like a service provider vis à vis non-UMTS traffic, having different billing policies as a function of the type of traffic may be envisaged: Internet service providers may use the UMTS access network, but also end users who merely require access to the Internet, without the UMTS facility. It is then clear that those users must be billed at a lower rate than UMTS users. From the network point of view, it is therefore necessary to be able to distinguish between them.

The invention provides a way of making this distinction. For example, the access router is then in a position to notify a billing server, indicating if the stream concerned corresponds to a mobile telephone standard or not.

Additionally, in one embodiment of the invention, the client information is used to convey more precise information on the client. It then becomes possible to adapt the billing policy to the client with greater refinement, and in particular to the quality of service requested by the client (gold, silver, bronze, etc.).

The access router may also use the information that it has on the client to provide other services such as traffic management, dynamic network configuration, etc.

1. Telecommunication terminal (T_{U}) comprising means for transmitting a stream (fᵤ) of packets of data to an access router (R) to a telecommunication network (N), characterized in that it comprises means for inserting client information into said stream indicating if said stream corresponds to a mobile telephone standard.

2. Telecommunication terminal according to claim 1, wherein said standard is the Universal Mobile Telecommunication System (UMTS) standard.

3. Telecommunication terminal according to claim 1, wherein said client information is inserted into a header of said packets.

4. Telecommunication terminal according to claim 3, wherein said client information is inserted into a hop-by-hop option header of said packets.

5. Router belonging to a telecommunication network, comprising means for receiving streams of packets of data, characterized in that it comprises means for determining if said stream corresponds to a mobile telephone standard from client information inserted in said stream and means for implementing quality of service assurance mechanisms as a function of what is determined in this way.

6. Router according to claim 5, taking the form of an access router to said telecommunication network.

7. Router according to claim 5, wherein said quality of service assurance mechanisms depend on other information on the client contained in said stream.

8. Router according to claim 5, additionally comprising means for notifying a billing server, indicating if said stream corresponds to a mobile telephone standard.
